(19) United States
(12) Patent Application Publication
(10) Pub. No.: US 2015/0178669 A1
(43) Pub. Date: Jun. 25, 2015

(54) Secured Delivery

(71) Applicant: Wal-Mart Stores, Inc., Bentonville, AR (US)

(72) Inventors: David Jon Carr, Mountain View, CA (US); Richard Mark Ramsden, Foster City, CA (US)

(73) Assignee: Wal-Mart Stores, Inc., Bentonville, AR (US)

(21) Appl. No.: 14/136,395

(22) Filed: Dec. 20, 2013

(51) Int. Cl. G06Q 10/08; H04N 7/14; B65D 51/24; G06Q 30/06

(52) U.S. Cl. CPC G06Q 10/083; G06Q 30/0635; H04N 7/141; B65D 51/245; B65D 2101/00

(57) ABSTRACT

The current disclosure extends to delivery of one or more items secured within a tote to a customer at a selected location by a delivery associate who may not be granted immediate access to the secured items. Embodiments of the present disclosure include an order processing module for receiving and processing transactions, an application server for transmitting instructions to an item originator, thereby directing the item originator to place the item into the tote and lock or otherwise secure the tote, and one or more user devices for conducting a video call between a verifier and the recipient. By verifying that no intermediate carrier had access to the contents of the secure tote and by verifying the identity of the recipient via the video call, it may be presumed that the chain of custody of the secured item passed directly from the item originator to the recipient.

### BACKGROUND

Currently, a customer of a grocery store or other retailer may request that items purchased from the retailer be delivered to a selected location such as the customer's residence or place of business. In some cases, a retailer may allow customers to order items via a website or other remote ordering apparatus, and then deliver the ordered items from a store that is local to the customer.

For example, a grocery retailer may provide a website having a food ordering functionality, by which a customer may: select one or more grocery products for purchase, make payment, and input a delivery address. The grocery retailer may then carry out the customer's order by assembling a delivery group of the purchased items at a retail store having geographic proximity to the address supplied by the customer, loading the delivery group into a delivery vehicle, and transporting the delivery group to the delivery address.

Alternatively, a delivery group may be assembled at a retail store and delivered to a customer just outside the store, for example in a parking lot. Thus, a customer may submit an order for one or more items, drive to the store, park in a designated parking location, and thereat receive the ordered items without entering the store.

However, it may be desirable that some items are not delivered to a customer without verifying the customer's identity or otherwise communicating directly with the customer before disbursing purchased items. Further, it may be desirable to prevent any intermediate delivery personnel from accessing or viewing the contents of an order. For example, certain local, state, and/or federal laws may prohibit a third party from learning the contents of a pharmacy order.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a block diagram illustrating components of a secured delivery system according to an embodiment of the present disclosure;

FIG. 2 is an illustration of a secured tote according to embodiments of the present disclosure; and

FIG. 3 is a flow chart illustrating an example method for delivering secured items in accordance with embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

The present disclosure extends to methods, systems, and computer programs for delivering purchased items to a verified customer and or exchanging additional information to and/or from the customer. In the following description, reference is made to the accompanying drawings that form a part hereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flowchart and block diagram in the attached figures illustrate the architecture, functionality, and operation of possible implementations of systems, methods, and computer program products according to various embodiments of the present disclosure. In this regard, each block in the flowchart or block diagram may represent a module, segment, or portion of code, which comprises one or more executable instructions for implementing the specified logical function(s). It will also be noted that each block of the block diagram and/or flowchart illustration, and combinations of blocks in the block diagram and/or flowchart illustration, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

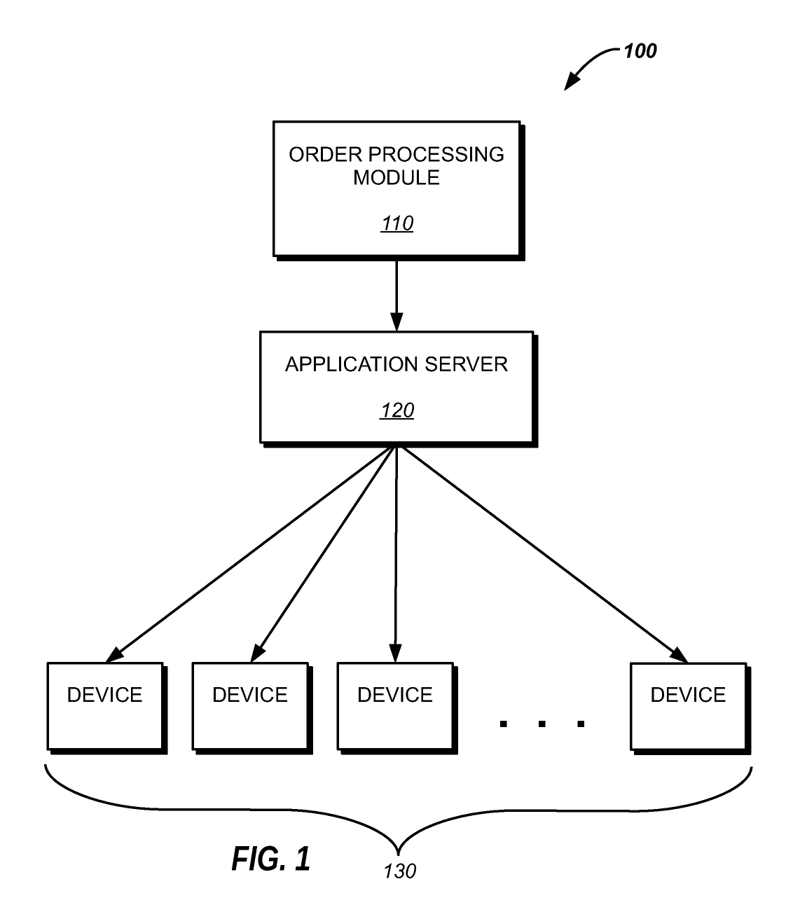

Embodiments of the present disclosure allow customers of a retailer or other provider to request secured delivery of one or more items. In embodiments, delivered items may include one or more products sold by the retailer. Delivered items may include, but are not limited to: groceries, pharmacy items, medical devices, documents, foods, office supplies, clothing wares, any other fungible goods sold by a retailer, commercial products, industrial goods, and the like. A retailer or other provider may typically operate and manage the systems disclosed and described herein or may enter into service agreements with a third party to operate and manage the systems. Referring now to FIG. 1, a secured delivery system 100 of the present disclosure is illustrated. According to the present disclosure, embodiments of the secured delivery system 100 comprise an order processing module 110, application server 120, and user devices 130.

In embodiments, order processing module 110 is adapted to receive data related to a completed transaction. The completed transaction may be completed at a retailer website, over via a phone system, at a drive-up kiosk, or by other retailer systems for carrying out a transaction. Data related to a completed transaction may include the identity of the customer, the delivery location, the items purchased, and other data related to the transaction. Order processing module 110 may receive such transaction data from any one of a variety of sources, depending on how and/or on which system the transaction was carried out. For example, transaction data may be input from a point of sale terminal for a transaction that was completed in-store, from a web server for a transaction that was completed on a retailer's web site, from a telephone sales representative for a transaction that was completed via telephone, from a drive-up kiosk terminal, etc.

Upon reception of transaction data at order processing module 110, data can be transmitted to application server 120. Application server 120 is adapted to transmit instructions to one or more user devices 130 to direct one or more picker associates to gather purchased items into a delivery group. In one embodiment, the picker associates are employees of the retailer and carry a mobile user device 130 with them to receive instructions, such as those set forth above. According to embodiments, the picker associate can view a list of items purchased in the transaction, locate the items from store or warehouse shelves, and gather the items in a delivery group.

User device 130 may be embodied in a variety of types of devices. In an example embodiment, user device 130 comprises a smartphone or other like mobile device having data and computer-readable instructions stored thereon that direct the device 130 to carry out the functions described in the present disclosure.

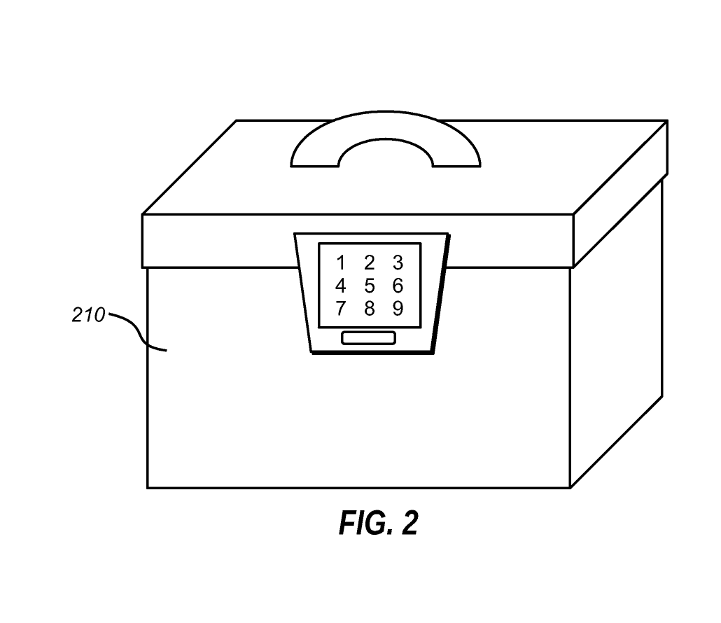

In one embodiment, an item purchased by a customer comprises a drug, medical device, or other substance or item controlled by prescription. A pharmacist or like employee may receive instructions regarding a purchased controlled item via a user device 130 that identifies the item. In some cases, the pharmacist may be required by law to only dispense such substance or device directly to the purchaser with no intermediate carriers. In some cases, the pharmacist may be required to verify the purchaser's identity before dispensing the substance or device. In order to maintain the security of a controlled substance or device, the pharmacist can place the purchased pharmacy item in a secure tote 210 (an embodiment of which is depicted in FIG. 2) and lock the tote 210 with a key code. A picker associate may then be directed by his/her mobile device 130 to pick up the locked tote 210 and add it to a delivery group. The pharmacist or other person responsible for placing the secured item into tote 210 may be referred to herein as the “item originator.”

The delivery group can be delivered to the customer at the selected location by an associate and/or driver. A person responsible for delivering a delivery group to a customer may be referred to herein as a “delivery associate.” The delivery associate may give the delivery group, including the secure tote 210, to the customer. While interacting with the customer, the delivery associate may ask the customer to participate in a video and/or audio call with the pharmacist. The video call may be carried out on the delivery associate's device 130, which can be in communication with the pharmacist's device 130. During the course of a conversation between the pharmacist and the customer, the pharmacist may provide any pertinent information and instructions to the customer regarding the purchased items, answer questions the customer has regarding the items, and verify the customer's identity, as may be required by law or the retailer's policy. The pharmacist may then divulge the key code to the customer, so that the customer can open the tote 210 and retrieve the pharmacy items. The delivery associate may then take the empty tote 210 back to the store or warehouse for the next delivery.

In embodiments, the pharmacist who prepared the secured tote 210 may not be the same pharmacist that interacts with the customer via the video call. In any case, the person with whom the customer interacts via the video call may be referred to herein as the “verifier.”

In embodiments, devices 130 communicate with each other through cellular data networks or other communications networks. Devices 130 can communicate via a virtual private network (“VPN”) or via other secure means of transmitting data in a secure fashion to maintain the confidentiality of sensitive information pertaining to the secured items. In embodiments, communications may be effected over various networks including, but not limited to, a wireless network, a cellular network, an intranet, the Internet, or combinations thereof.

In embodiments, virtually any type of item may be secured in tote 210 or like container for secure point-to-point delivery, while maintaining a sufficient chain of custody by virtue of the secure tote 210. Such delivery may be carried out by a common carrier or the like. For example, sensitive documents may be locked in tote 210 by a person having authorization to view the documents. The locked tote 210 may then be passed through a number of transporters until it reaches a designated recipient. In embodiments, the recipient may be verified by the sender or other person via a video phone call carried out on linked mobile devices prior to transmission of the key code to unlock the tote 210. In embodiments, a physical key may be sent to the recipient for unlocking and opening the tote 210. In embodiments, tamper-evident tape or packaging is used instead of, or in addition to, a physical locking device to secure the tote 210 closed. During the video call, the recipient may confirm to the sender or other video call participant that the tamper-evident tape or packaging shows no sign of tampering and it may then be assumed that the contents of tote 210 have remained secure.

In embodiments, tote 210 comprises a light safe that is durable and strong enough to discourage theft but light enough to allow for hand delivery. The tote 210 may include a combination or other number-based locking mechanism. In embodiments, tote 210 comprises an integrated GPS receiver so that system 100, pharmacist, and/or other administrator may track the movement and locations of tote 210. Tote 210 may be configured to open only if the GPS receive indicates that tote 210 has been transported to the intended delivery location. In embodiments, tote 210 is refrigerated and/or heated to maintain temperature for sensitive secured items. In embodiments, tote 210 comprises external identifying markings so that a delivery associate may readily associate the tote 210 with its respective delivery group and/or delivery destination.

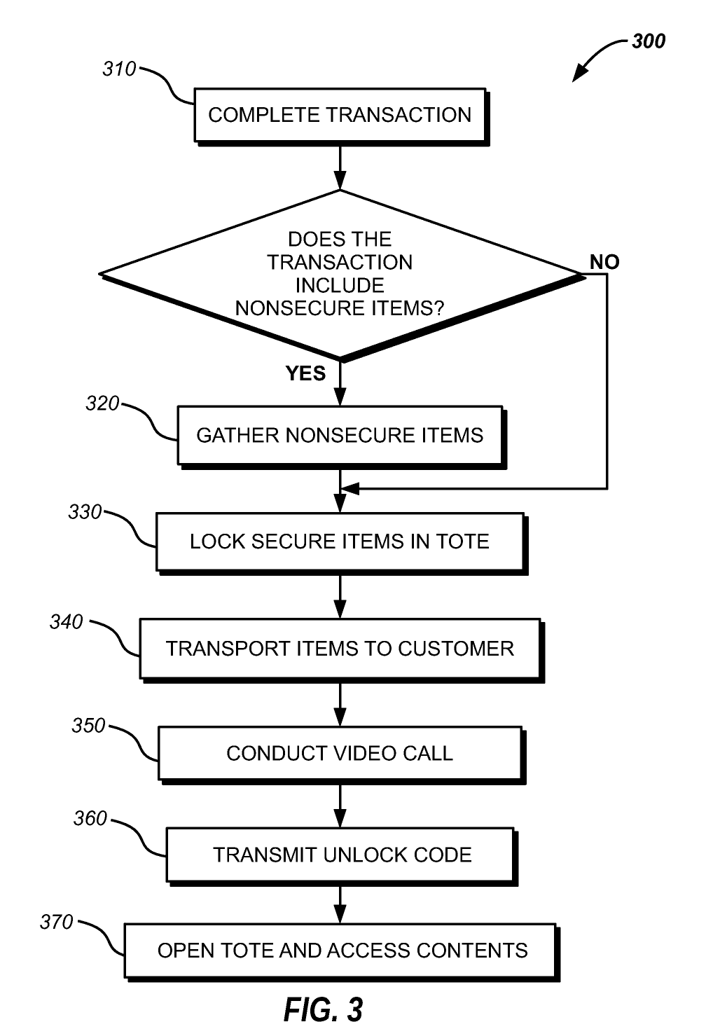

In operation, one or more products may be securely delivered to a customer in a secure tote 210. Referring now to FIG. 3, embodiments of the present disclosure comprise method 300. At operation 310, a customer may select various items to purchase via a retail interface and make payment. In embodiments, the retail interface is provided at a retailer's website at the customer's home, place of business, or other location. In other embodiments, the customer selects items via a drive-up or other kiosk, for example in the retailer's parking area. While selecting items for purchase, the customer may be given the option to fill one or more prescriptions. Upon selecting all items for purchase, the customer can complete the transaction by entering payment details and submitting the order and order processing module 110 can transmit data regarding the purchased items to application server 120. In alternate embodiments, a customer completes a transaction at a web browser, for example at home, receives a transaction code, and presents the transaction code at a kiosk to pick up the purchased items.

At operation 320, if the customer is purchasing any non-secure items, application server 120 transmits instructions to one or more picker associates to locate and gather the non-secure items. The items may be gathered from shelves in a retail store, warehouse, or other facility. the non-secure items may be collected in a bin, a cart, a box, or other container for transporting the items to the customer.

At operation 330, application server 120 instructs pharmacist or other secured item sender to gather any secured items, place such items into tote 210, lock tote 210, and make a note of the tote key code, if any (or alternatively, apply tamper-evident tape across tote opening). In embodiments, a tote 210 having transparent walls and/or a window may be used if desirable that the contents may be ascertained without opening the tote 210. In alternative embodiments, a tote 210 having opaque walls may be used when privacy concerns prioritize confidentiality and concealment of the items placed within tote 210.

At operation 340, tote 210 and any additional purchased items are transported to the customer at a location selected by the customer and/or determined by the ordering process used. For example, a purchase entered at a drive-up kiosk may indicate that the customer desires to receive the purchased items in the vicinity of the kiosk or other designated pick-up location. For home, office, or other remote deliveries, tote 210 may be transported to the address entered by the customer by a delivery associate or carrier. In embodiments, the delivery associate may receive delivery instructions, including directions, from device 130. Device 130 may additionally alert the delivery associate that a particular delivery includes secured items and a tote 210

At operation 350, the delivery associate or carrier may hand tote 210 and a mobile device 130 to the customer to conduct a video call with the pharmacist or other sender of the secured item(s). The mobile device 130 used by the customer may be connected to the pharmacist's device 130 via a VPN or other secured connection. During the video call, the customer may visually verify that he or she is speaking with the pharmacist (for example, indicia of a pharmacist may include a white lab coat, a nametag, or other indicia appearing on the display of device 130 for the customer to see). The customer may ask questions or receive relevant instructions from the pharmacist regarding the purchased pharmacy items. The pharmacist may ask for personal information to verify the customer's identity. In embodiments, the customer may apply a signature to the device 130 as part of the exchange. The video call may be made out of view and/or hearing of the delivery associate to maintain confidentiality of the customer. In embodiments, a mere audio call is completed between the pharmacist and the customer, rather than a video call.

At operation 360, upon satisfaction of the pharmacist that the customer's identity has been verified, the key code for the tote 210 lock may be given verbally by the pharmacist to the customer. At operation 370, the customer may enter the unlock code to access and remove the secured items. Alternatively, an unlock command may be electronically transmitted from the pharmacist's device 130 to the tote 210, thereby unlocking tote 210 without the customer's input.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. A method for securely delivering an item to a recipient comprising:
at an order processing module, receiving a request to purchase the item;
transmitting instructions to an item originator to insert the item into a container;
locking the container;
transporting the container to the recipient;
initiating a video call between a verifier and the item recipient;
transmitting a code from the verifier to the recipient, wherein the code unlocks the container.

2. The method of claim 1, wherein initiating a video call between the item originator and the item recipient further comprises verifying, by the item originator, of the recipient's identity.

3. The method of claim 1, wherein initiating a video call between the item originator and the item recipient comprises transmitting the video call to a mobile device at the recipient.

4. The method of claim 1, wherein transmitting a code from the item originator to the recipient comprises a verbal recitation of the code by the item originator.

5. The method of claim 1, wherein transmitting a code from the item originator to the recipient comprises a transmission of a digital representation of the code.

6. The method of claim 1, wherein locking the container comprises applying tamper-evident tape to the container.

7. The method of claim 1, wherein locking the container comprises securing closed a tamper-evident container.

8. The method of claim 1, wherein the verifier and the item originator are the same person.

9. The method of claim 1, wherein transporting the container to the recipient further comprises delivering an item order at a drive-up kiosk.

10. A method for securely delivering an item to a recipient comprising:
assembling an order comprising at least one controlled item;
placing the at least one controlled item into a tote;
securing the tote with an unlock code;
handing the tote to a delivery associate;
participating in a video call with the recipient;
verifying an identify of the recipient; and
transmitting the unlock code to the recipient.

11. The method of claim 10, wherein the at least one controlled item comprises an item controlled by prescription.

12. The method of claim 10, wherein the at least one controlled item comprises a confidential document.

13. The method of claim 10, wherein participating in a video call with the recipient comprises transmitting the video call to a mobile device at the recipient.

14. The method of claim 10, wherein transmitting the unlock code to the recipient comprises a verbal recitation of the unlock code by the item originator.

15. The method of claim 10, wherein transmitting the unlock code to the recipient comprises a transmission of a digital representation of the unlock code.

16. The method of claim 10, further comprising applying a strip of tamper-evident tape to the tote.
